(19) United States
(12) Patent Application Publication
(10) Pub. No.: US 2026/0134441 A1
(43) Pub. Date: May 14, 2026

(54) REGULATORY-EXECUTABLE ARTIFICIAL INTELLIGENCE GOVERNANCE SYSTEM

(71) Applicant: George William Bickerstaff, III, Greenwich, CT (US)

(72) Inventor: George William Bickerstaff, III, Greenwich, CT (US)

(21) Appl. No.: 19/443,546

(22) Filed: Jan. 8, 2026

(51) Int. Cl. G06Q 30/018; G06N 20/00

(52) U.S. Cl. CPC G06Q 30/018; G06N 20/00

(57) ABSTRACT

A regulatory-executable artificial intelligence governance system is disclosed that transforms regulatory requirements into machine-executable compliance constraints enforced at execution time. The system dynamically determines applicable jurisdiction contexts, evaluates proposed artificial intelligence actions against executable regulatory logic, and permits, modifies, escalates, or blocks execution prior to commitment. Automated regulatory updates and audit artifact generation enable continuous, preventive compliance in regulated environments.

### TECHNICAL FIELD

The present invention relates to artificial intelligence governance systems and, more particularly, to systems and methods for transforming regulatory, legal, and policy requirements into machine-executable constraints that are enforced in real time during artificial intelligence operations.

### BACKGROUND

Artificial intelligence systems are increasingly deployed in regulated environments including finance, healthcare, energy, transportation, and government operations. Existing compliance approaches rely primarily on post-hoc audits, documentation, and manual reporting, which are insufficient for autonomous or semi-autonomous systems operating at machine speed. Regulatory frameworks are typically expressed in human-readable legal language and are not directly enforceable by computational systems without interpretation and manual intervention.

As artificial intelligence systems gain autonomy, the absence of execution-time regulatory enforcement introduces legal risk, operational uncertainty, and systemic exposure. Organizations face fragmented jurisdictional requirements, increasing regulatory scrutiny, and escalating penalties for non-compliance. There is therefore a need for a technical system that converts regulatory requirements into executable governance logic and enforces such logic automatically prior to and during artificial intelligence decision execution.

### SUMMARY OF THE INVENTION

The invention provides a regulatory-executable artificial intelligence governance system that converts human-readable regulatory requirements into machine-executable compliance constraints and enforces those constraints at execution time within artificial intelligence systems. The system dynamically determines applicable jurisdiction contexts, evaluates proposed artificial intelligence actions against executable regulatory logic, and permits, modifies, escalates, or blocks such actions prior to execution.

By embedding regulatory enforcement directly into execution pathways, the system prevents non-compliant state transitions before computational or transactional resources are committed. Automated regulatory update synchronization, jurisdictional conflict resolution, and generation of regulator-ready audit artifacts transform compliance from a reporting function into a preventive, machine-enforced control mechanism.

### DEFINITIONS (ALPHABETICAL—EXACTLY TEN)

Action Proposal: A machine-generated or human-initiated request for an artificial intelligence system to perform an operation.

Audit Artifact: A machine-generated record demonstrating compliance with applicable regulatory constraints for an executed, modified, escalated, or blocked action.

Compliance Constraint: A machine-executable rule derived from a regulatory requirement.

Conflict Resolution Engine: A component configured to resolve inconsistencies between applicable compliance constraints using predefined precedence logic.

Execution Gate Controller: A control component that intercepts an action proposal prior to execution and coordinates compliance evaluation.

Jurisdiction Context: A set of geographic, legal, and regulatory attributes applicable to an action proposal.

Policy Translation Engine: A component configured to convert regulatory text into executable compliance constraints.

Regulatory Source: An authoritative body issuing laws, regulations, or policies.

Runtime Enforcement Layer: A collection of components that evaluate and enforce compliance constraints prior to action execution.

Update Synchronization Module: A system module that maintains current executable compliance constraints as regulatory requirements change.

### BRIEF DESCRIPTION OF THE DRAWINGS

FIG. 1 illustrates the regulatory translation architecture for converting regulatory sources into executable compliance constraints.

FIG. 2 illustrates execution-time compliance gating within the runtime enforcement layer.

FIG. 3 illustrates jurisdiction context detection, rule selection, and conflict resolution.

FIG. 4 illustrates regulatory update synchronization and rule regeneration.

FIG. 5 illustrates audit generation, reporting, and long-term compliance archival.

### DETAILED DESCRIPTION OF THE INVENTION

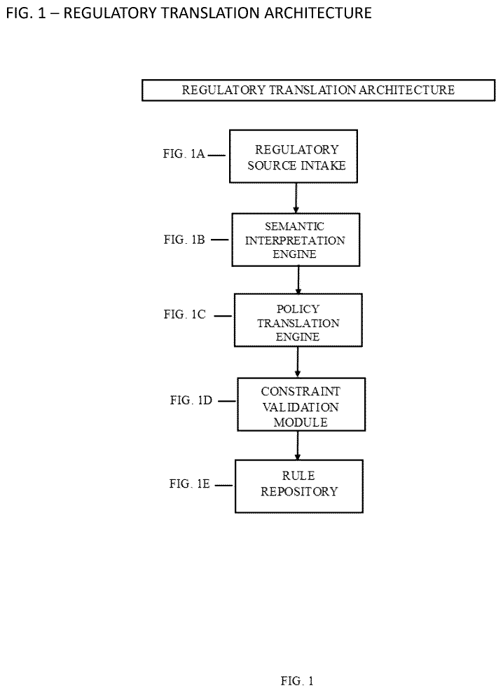

### FIG. 1—Regulatory Translation Architecture

FIG. 1A illustrates regulatory source intake, wherein regulatory sources are ingested in structured or unstructured formats and validated for authenticity and versioning.

FIG. 1B illustrates a semantic interpretation engine that analyzes regulatory language to extract obligations, prohibitions, thresholds, and conditions and map such elements into formal logic representations.

FIG. 1C illustrates the policy translation engine, which converts interpreted regulatory elements into executable compliance constraints traceable to their originating regulatory sources.

FIG. 1D illustrates a constraint validation module that tests executable compliance constraints for logical consistency, enforceability, and redundancy prior to deployment.

FIG. 1E illustrates a rule repository storing validated compliance constraints indexed by jurisdiction context, regulatory domain, and applicability.

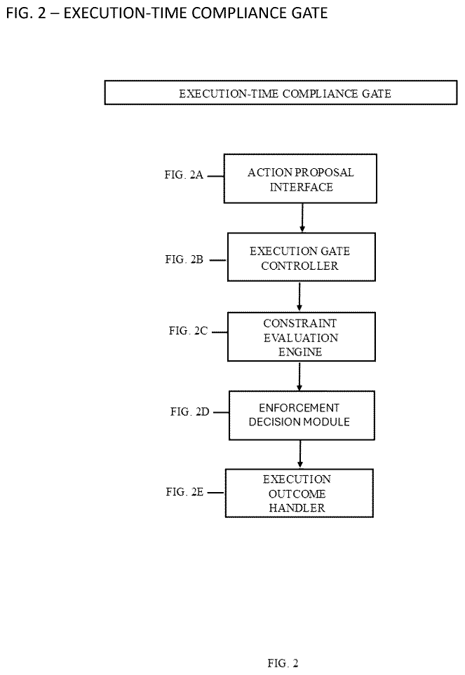

### FIG. 2—Execution-Time Compliance Gate

FIG. 2A illustrates an action proposal interface through which an action proposal is generated and submitted for compliance evaluation.

FIG. 2B illustrates the execution gate controller, which intercepts the action proposal prior to execution and retrieves applicable compliance constraints.

FIG. 2C illustrates a constraint evaluation engine that evaluates the action proposal against applicable executable compliance constraints.

FIG. 2D illustrates an enforcement decision module that determines whether the action proposal is permitted, modified, escalated, or blocked based on evaluation results.

FIG. 2E illustrates an execution outcome handler that records outcomes and generates audit artifacts for reporting and archival.

### The components illustrated in FIGS. 2a-2e collectively comprise the runtime enforcement layer.

### Example Execution—Time Compliance Scenario

In one example embodiment, an artificial intelligence system generates an action proposal to perform an operation involving regulated data processing. The action proposal is submitted through the action proposal interface illustrated in FIG. 2A and intercepted by the execution gate controller illustrated in FIG. 2B prior to execution.

Upon interception, a jurisdiction context applicable to the action proposal is determined based on contextual attributes associated with the operation. Applicable compliance constraints are selected and evaluated by the constraint evaluation engine illustrated in FIG. 2C within the runtime enforcement layer, prior to commitment of computational or transactional resources.

Based on the evaluation results, the enforcement decision module illustrated in FIG. 2D determines that the action proposal requires modification to satisfy one or more compliance constraints. The modified action proposal is permitted to proceed to execution, with the outcome recorded by the execution outcome handler illustrated in FIG. 2E. An audit artifact is generated linking the action proposal, the applied compliance constraints, and the enforcement decision.

This example is provided for illustrative purposes only, and the invention is not limited to the specific sequence, context, or enforcement outcome described.

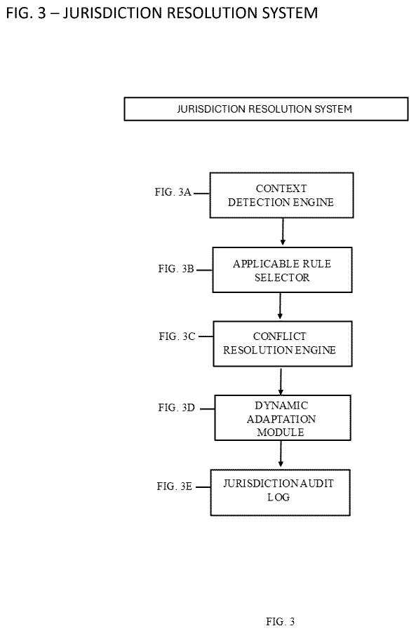

### FIG. 3—Jurisdiction Resolution System

FIG. 3A illustrates a context detection engine configured to determine a jurisdiction context applicable to an action proposal.

FIG. 3B illustrates an applicable rule selector that selects compliance constraints relevant to the detected jurisdiction context.

FIG. 3C illustrates the conflict resolution engine that resolves conflicting compliance constraints using predefined precedence logic.

FIG. 3D illustrates a dynamic adaptation module that re-evaluates constraints if the jurisdiction context changes during execution.

FIG. 3E illustrates a jurisdiction audit log that records jurisdiction determinations and resolution outcomes.

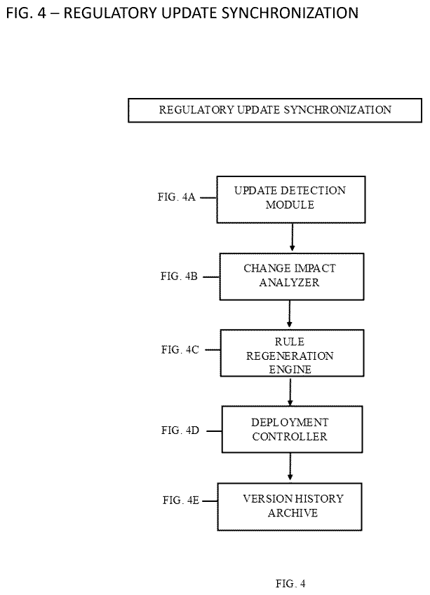

FIG. 4—Regulatory Update Synchronization

FIG. 4A illustrates an update detection module that detects changes to regulatory sources.

FIG. 4B illustrates a change impact analyzer that determines the impact of detected updates on existing compliance constraints.

FIG. 4C illustrates a rule regeneration engine that generates updated executable compliance constraints.

FIG. 4D illustrates a deployment controller that deploys updated constraints without system downtime.

FIG. 4E illustrates a version history archive that preserves historical versions of executable compliance constraints.

In some embodiments, the update synchronization module comprises the components illustrated in FIGS. 4A-4E.

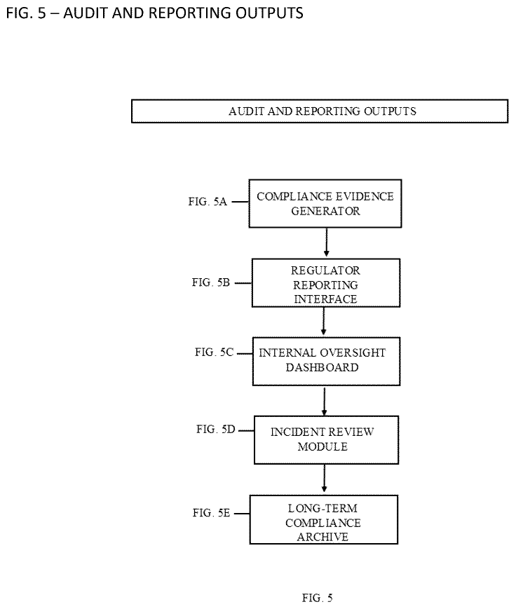

### FIG. 5 —Audit and Reporting Outputs

FIG. 5A illustrates a compliance evidence generator that produces audit artifacts linking actions to enforced compliance constraints.

FIG. 5B illustrates a regulator reporting interface that formats audit artifacts for submission to regulatory bodies.

FIG. 5c Illustrates an internal oversight dashboard providing real-time compliance visibility.

FIG. 5D illustrates an incident review module supporting post-hoc review of blocked or escalated actions.

FIG. 5E illustrates a long-term compliance archive that securely stores audit artifacts in accordance with retention policies.

1. A regulatory-executable artificial intelligence governance system, comprising:
a policy translation engine configured to convert regulatory text from one or more regulatory sources into machine-executable compliance constraints;
a runtime enforcement layer comprising an execution gate controller, a constraint evaluation engine, and an enforcement decision module, the runtime enforcement layer being configured to intercept an action proposal prior to execution;
a jurisdiction context determination component configured to identify geographic, legal, and regulatory attributes applicable to the action proposal;
wherein the runtime enforcement layer evaluates the action proposal against applicable compliance constraints based on the jurisdiction context and, prior to execution, determines whether to permit, modify, escalate, or block the action proposal.

2. A method for governing artificial intelligence operations, comprising:
receiving an action proposal generated by an artificial intelligence system;
determining a jurisdiction context applicable to the action proposal;
selecting executable compliance constraints applicable to the jurisdiction context;
evaluating the action proposal against the selected compliance constraints within a runtime enforcement layer prior to execution; and
based on the evaluation, permitting, modifying, escalating, or blocking execution of the action proposal.

3. A non-transitory computer-readable medium storing instructions that, when executed by one or more processors, cause a system to:
convert regulatory text into executable compliance constraints using a policy translation engine;
intercept an action proposal prior to execution using an execution gate controller;
determine a jurisdiction context applicable to the action proposal;
evaluate the action proposal against the compliance constraints within a runtime enforcement layer; and
prevent execution of the action proposal when the evaluation indicates non-compliance.

4. The system of claim 1, wherein the policy translation engine converts regulatory text into executable compliance constraints using semantic interpretation of obligations, prohibitions, thresholds, and conditions.

5. The system of claim 1, wherein the runtime enforcement layer performs compliance evaluation synchronously prior to commitment of computational or transactional resources.

6. The system of claim 1, further comprising a conflict resolution engine configured to resolve conflicting compliance constraints applicable to the jurisdiction context using predefined precedence logic.

7. The method of claim 2, wherein evaluating the action proposal includes dynamically re-evaluating compliance constraints when the jurisdiction context changes during execution.

8. The system of claim 1, further comprising an update synchronization module configured to detect regulatory changes and regenerate executable compliance constraints without system downtime.

9. The system of claim 1, further comprising generation of one or more audit artifacts that link the action proposal, the applied compliance constraints, and the enforcement decision.

10. The non-transitory computer-readable medium of claim 3, wherein enforcement decisions and audit artifacts are stored in a tamper-resistant archive for regulatory review.
